(19) United States
(12) Patent Application Publication
(10) Pub. No.: US 2026/0318833 A1
(43) Pub. Date: Oct. 15, 2026

(54) FLUORESCENT PROBE AND OBSERVATION METHOD USING FLUORESCENT PROBE

(71) Applicants: Kyoto University, Kyoto-shi, Kyoto (JP); DAICEL CORPORATION, Osaka-shi, Osaka (JP)

(72) Inventors: Norikazu MIZUOCHI, Kyoto-shi (JP); Izuru OHKI, Kyoto-shi (JP); Masanori FUJIWARA, Kyoto-shi (JP); Tzekit SO, Kyoto-shi (JP); Naoya MORIOKA, Kyoto-shi (JP)

(73) Assignees: Kyoto University, Kyoto-shi, Kyoto (JP); DAICEL CORPORATION, Osaka-shi, Osaka (JP)

(21) Appl. No.: 19/485,864

(22) PCT Filed: May 23, 2024
(86) PCT No.: PCT/JP2024/019022

§ 371 Date: Nov. 19, 2025

(30) Foreign Application Priority Data
Jun. 5, 2023 (JP) 2023-092423

(51) Int. Cl. G01N 21/64; G01N 21/84; G01N 21/95

(52) U.S. Cl. CPC G01N 21/6456; G01N 21/95; G01N 2021/646; G01N 2021/6471; G01N 2021/8477; G01N 2201/121

(57) ABSTRACT

Provided is an improved fluorescent probe that can remove or reduce autofluorescence without irradiating a diamond having a color center with microwaves. In a fluorescent probe (10), a surface of a diamond particle (1) having a color center is coated with a substance (2) that absorbs light and releases heat. A relationship between an intensity of light irradiated onto the fluorescent probe (10) and an intensity of fluorescence emitted from the fluorescent probe (10) is nonlinear.

### TECHNICAL FIELD

The present invention relates to a fluorescent probe using a diamond having a color center and an observation method using the fluorescent probe.

### BACKGROUND ART

In a crystal structure of diamond, a complex defect called a nitrogen vacancy center may be observed. The nitrogen-vacancy center is formed of a pair of a nitrogen atom substituted for a carbon atom in a crystal lattice and a vacancy present at a position adjacent to the nitrogen atom (where a carbon atom has been removed), and is also called a Nitrogen Vacancy center (NV center). In addition to the NV center, a complex defect called a silicon-vacancy center or a complex defect called a germanium vacancy center may be observed in the crystal structure of the diamond. These complex defects including the NV center are called color centers.

The diamond has unique optical and magnetic properties derived from such a color center. Since the diamond is a substance composed of carbon atoms, it is considered to have extremely low toxicity to living bodies and also has high biocompatibility. Since a surface of the diamond can be easily chemically modified, the diamond is not only used as a material for quantum information devices and electronic circuit devices, but also has been used in a wide range of applications such as diagnosis, treatment, and imaging in a biomedical field. For example, an inside of a cell of a living body is observed by introducing the diamond containing such a color center into the cell of the living body and using a fluorescence microscope, a confocal laser microscope, or the like.

For example, Patent Document 1 discloses that the diamond containing the NV center is introduced into a cell as a fluorescent probe, and two-dimensional visual field observation of an intensity of fluorescence emitted from the fluorescent probe inside the cell is performed. Autofluorescence is known as one of problems of a signal-to-noise ratio (S/N ratio) in observing fluorescence, and in Patent Document 1, the autofluorescence is removed by utilizing a fact that the intensity of the fluorescence emitted from the diamond containing the NV center decreases during ESR (electron spin magnetic resonance). The magnetic resonance is generated by irradiating the diamond containing the NV center with microwaves at a specific frequency using a high-frequency oscillator.

In addition, for example, Non-Patent Document 1 discloses in vitro biosensing for detecting a virus with high sensitivity using a fluorescent nanodiamond functionalized with a biomolecule. Autofluorescence is removed by observing modulation by microwaves.

### CITATION LIST

### Patent Document

Patent Document 1: JP 2011-180570 A

### Non-Patent Document

Non-Patent Document 1: Miller, B. S., Bezinge, L., Gliddon, H. D. et al. “Spin-enhanced nanodiamond biosensing for ultrasensitive diagnostics”, Nature 587, 588-593 (2020). https://doi. org/10.1038/s41586-020-2917-1

### SUMMARY OF INVENTION

### Technical Problem

In order to remove the autofluorescence, an apparatus for generating microwaves and performing irradiation of microwaves has been used until now, In order to further promote the use of the diamond containing the color center as the fluorescent probe, it is required to remove or reduce the autofluorescence more easily.

An object of the present invention is to provide an improved fluorescent probe that can remove or reduce the autofluorescence without irradiating the diamond containing the color center with microwaves.

### Solution to Problem

The present inventors have conducted intensive studies to solve the above problems, and found that when a diamond particle having a color center, the surface of which is coated with a substance that absorbs light and releases heat, is used as a fluorescent probe as shown in FIG. 1, nonlinearity occurs between an intensity of light irradiated onto the fluorescent probe and an intensity of fluorescence emitted from the fluorescent probe as shown in FIG. 3(A).

Therefore, as a main point of an observation method is shown in FIG. 3(B), such a fluorescent probe having a nonlinear relationship between the intensity of the irradiated light and the intensity of the emitted fluorescence is irradiated with light at first and second intensities I₁ and I₂, and thus first and second fluorescence images F₁ and F₂ are created, and a difference in intensities of fluorescence between the created first and second fluorescence images F₁ and F₂ is provided. This makes it possible to observe a fluorescence image with autofluorescence being removed or reduced, without irradiating the fluorescent probe with microwaves for generating magnetic resonance. In the fluorescence image obtained by providing the difference in intensities of fluorescence, the autofluorescence is removed or reduced as shown in FIG. 6(B) and FIG. 12(B), and the intensity of the fluorescence emitted from the fluorescent probe is relatively enhanced.

That is, the present invention for solving the above problems includes, for example, the following aspects.

### (Item 1)

A fluorescent probe, wherein a surface of a diamond particle having a color center is coated with a substance that absorbs light and releases heat.

### (Item 2)

The fluorescent probe according to item 1, wherein a relationship between an intensity of irradiated light and an intensity of emitted fluorescence is nonlinear.

### (Item 3)

The fluorescent probe according to item 1 or 2, wherein a free radical is added to the coating.

### (Item 4)

The fluorescent probe according to any one of items 1 to 3, wherein the substance includes at least one of a dye molecule, graphene, graphite, a carbon nanotube, a polymer compound, a metal nanoparticle, an organic nanoparticle, or an inorganic nanoparticle.

### (Item 5)

The fluorescent probe according to any one of items 1 to 3, wherein the substance is polydopamine.

### (Item 6)

The fluorescent probe according to any one of items 1 to 5, wherein the color center is a silicon-vacancy complex defect.

### (Item 7)

An observation method using a fluorescent probe, the observation method including:
a first fluorescence image creating step including irradiating the fluorescent probe described in any one of items 1 to 6 with light at a first intensity and creating a first fluorescence image;
a second fluorescence image creating step including irradiating the fluorescent probe with light at a second intensity higher than the first intensity and creating a second fluorescence image; and
an enhanced image creating step including taking a difference in intensities of fluorescence between the first fluorescence image and the second fluorescence image, and creating an enhanced image having a relatively enhanced intensity of the fluorescence emitted from the fluorescent probe when the fluorescent probe is irradiated with the light at the second intensity.

### (Item 8)

The observation method according to item 7, wherein
the enhanced image creating step includes
correcting the intensity of the fluorescence of either the first fluorescence image or the second fluorescence image based on a ratio between the first intensity and the second intensity, taking a difference in intensities of fluorescence between the corrected one fluorescence image and the other fluorescence image, and thus creating the enhanced image.

### (Item 9)

The observation method according to item 7 or 8, wherein
the second fluorescence image creating step includes creating the second fluorescence image from fluorescence emitted from the fluorescent probe and passing through a wavelength filter, and
the wavelength filter is a long-pass filter configured to transmit light having a wavelength longer than a wavelength of a zero-phonon line of a color center included in the fluorescent probe.

### (Item 10)

The observation method according to item 7 or 8, wherein
the first fluorescence image creating step includes creating the first fluorescence image from fluorescence emitted from the fluorescent probe and passing through a wavelength filter, and
the wavelength filter is a short-pass filter configured to transmit light having a wavelength shorter than a wavelength of a zero-phonon line of a color center included in the fluorescent probe.

### Advantageous Effects of Invention

According to the present invention, there can be provided an improved fluorescent probe directed to enable the fluorescent probe to remove and reduce autofluorescence without irradiating a diamond containing a color center with microwaves.

### BRIEF DESCRIPTION OF DRAWINGS

FIG. 1 is a schematic view for explaining an outline of a fluorescent probe according to an embodiment.

FIG. 2 is views for explaining an apparatus used for fluorescence observation.

FIG. 3 is views for explaining a fluorescence observation method.

FIG. 4 is views for explaining a function of an analog acoustic optical modulator (AOM).

FIG. 5 is views schematically showing three kinds of fluorescent probes produced on glass substrates as examples and comparative examples in Example 1 to Example 3.

FIG. 6 is fluorescence images observed in Example 1, which are fluorescence images obtained by fluorescence observation using fluorescent probes according to an example and comparative examples.

FIG. 7 is spectra measured in Example 1, which are spectra of fluorescence emitted from PD-SiV whose surface is coated with polydopamine, the PD-SiV being the fluorescent probe according to the example.

FIG. 8 is spectra measured in Example 1, which are spectra of fluorescence emitted from PD-SiV whose surface is coated with polydopamine, the PD-SiV being the fluorescent probe according to the example.

FIG. 9 is spectra measured in Example 1, which are spectra of fluorescence emitted from D-SiV whose surface is not coated, the D-SiV being the fluorescent probe according to one of the comparative examples.

FIG. 10 is spectra measured in Example 1, which are spectra of fluorescence emitted from D-NV whose surface is not coated, the D-NV being the fluorescent probe according to another one of the comparative examples.

FIG. 11 is spectra measured in Example 1, which are spectra of fluorescence emitted from D-NV whose surface is not coated, the D-NV being the fluorescent probe according to the another one of the comparative examples.

FIG. 12 is fluorescence images observed in Example 2, which are fluorescence images obtained by fluorescence observation using fluorescent probes according to an example and comparative examples.

FIG. 13 is spectra measured in Example 2, which are spectra of fluorescence emitted from PD-SiV whose surface is coated with polydopamine, the PD-SiV being the fluorescent probe according to the example.

FIG. 14 is spectra measured in Example 2, which are spectra of fluorescence emitted from D-SiV whose surface is not coated, or of fluorescence emitted from D-NV whose surface is not coated, the D-SiV and the D-NV being fluorescent probes according to the comparative examples.

FIG. 15 is a fluorescence image obtained by the fluorescence observation using a fluorescent probe according to Example 3.

FIG. 16 is spectra of fluorescence indicated by a label “PD-SiV” in FIG. 15.

FIG. 17 is spectra of fluorescence indicated by a label “Bkg1” or “Bkg2” in FIG. 15.

FIG. 18 is fluorescence images obtained by the fluorescence observation using the fluorescent probes according to Example 3, which are respective fluorescence images obtained when the fluorescent probes are irradiated with light at different intensities.

FIG. 19 is fluorescence images including the portions indicated by the labels “Bkg1” and “Bkg2” in FIG. 15, among the fluorescence images shown in FIG. 18.

### DESCRIPTION OF EMBODIMENTS

Hereinafter, embodiments of the present invention will be described in detail with reference to the accompanying drawings. In the following description and drawings, the same reference signs denote the same or similar forms, and thus redundant description of the same or similar forms will be omitted.

### Fluorescent Probe

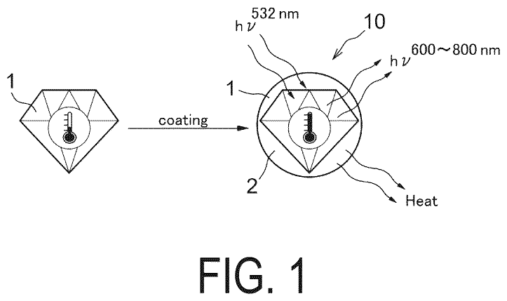

FIG. 1 is a schematic view for explaining an outline of a fluorescent probe according to an embodiment. In a fluorescent probe 10 according to an embodiment, a surface of a diamond particle 1 having a color center is coated with a substance 2 that absorbs light and releases heat.

The diamond 1 used in the fluorescent probe 10 is a diamond containing a color center. The color center emits fluorescence when irradiated with light having an excitation wavelength. Types of the color center include, for example, an NV center (nitrogen vacancy center), an SiV center (silicon vacancy center), and a GeV center (germanium vacancy center). In the present embodiment, the color center is the SiV center.

A size of the diamond 1 is, for example, nano-size or micro-size. A plurality of the nano-sized nanodiamonds having an average particle size of, for example, less than about 200 nm to about 5 nm are preferable, but the size of the diamond 1 is not limited as long as it can be used as the fluorescent probe. In the present embodiment, a plurality of the diamonds 1 are microdiamonds having an average particle size of about 1 μm.

The substance 2 coated on the surface of the diamond 1 is a substance that absorbs light and releases heat. The surface of the diamond 1 can be coated with a substance, such as a dye molecule, graphene, graphite, a carbon nanotube, a polymer compound, a metal nanoparticle, an organic nanoparticle, or an inorganic nanoparticle, as the substance 2 that absorbs light and releases heat. In the present embodiment, the surface of the diamond 1 is coated with polydopamine (PDA) that is a polymer compound. The polydopamine is obtained by polymerizing amino acid-derived dopamine that is a raw material for producing melanin.

Since the surface of the diamond particle 1 is coated with the substance 2 that absorbs light and releases heat, a temperature inside the diamond 1 rises when the fluorescent probe 10 is irradiated with light, and a spectrum of fluorescence emitted from the color center changes. This increases changes in a wavelength and an intensity of the emission in the color center, and nonlinearity occurs between the intensity of the irradiated light and the intensity of the emitted fluorescence. This nonlinearity further increases as the intensity of the light irradiated onto the fluorescent probe 10 increases.

In a case where an SiV center is used as the color center, the wavelength of the light with which the fluorescent probe 10 is irradiated is from about 500 nm to 700 nm, and the wavelength of the fluorescence emitted from the SiV center at this time is from about 700 nm to 800 nm. In the present embodiment, the wavelength of the light irradiated onto the fluorescent probe 10 is about 532 nm.

Preferably, a free radical can be added to the coating for the fluorescent probe 10. This promotes temperature rise of the substance 2 due to the irradiation with light, increases the change in an intensity of the luminescence of the color center, and further increases the nonlinearity occurring between the intensity of the irradiated light and the intensity of the emitted fluorescence. In the present embodiment, TEMPO that is an organic compound is added to the coating, as a substance that functions as the free radical. TEMPO is an abbreviation for 2,2,6,6-tetramethylpiperidine 1-oxyl.

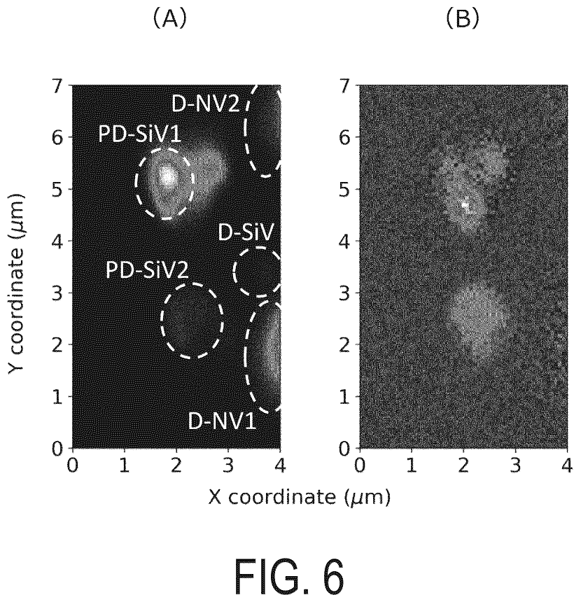

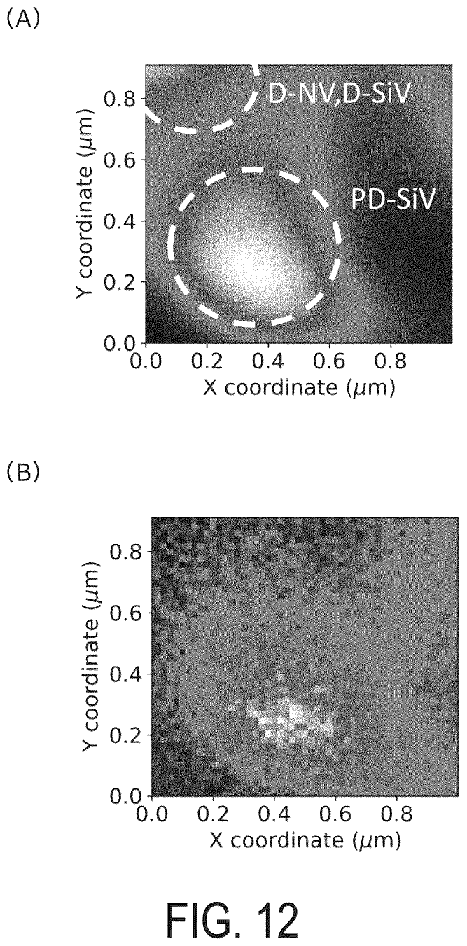

When a fluorescence image of the fluorescence emitted from the fluorescent probe 10 is created by irradiating the fluorescent probe 10 with light including the excitation wavelength of the color center according to an observation method to be described later, the intensity of the fluorescence emitted from the fluorescent probe 10 is relatively enhanced as shown in the fluorescence images of FIG. 6(B) and 12(B), and then the fluorescence image can be created with autofluorescence being removed or reduced. Each of the fluorescence images of FIG. 6(A) and 12(A) corresponds to a second fluorescence image F₂ defined in the observation method to be described later.

### Observation Apparatus

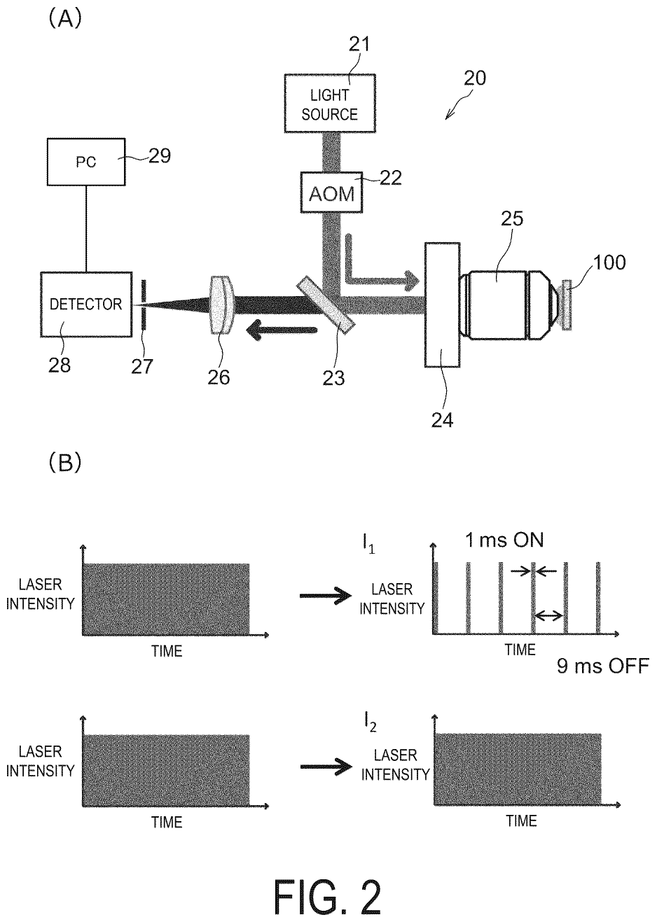

FIG. 2 is views for explaining an apparatus used for fluorescence observation. (A) is a view schematically showing a schematic form of the apparatus. (B) is views for explaining the function of an acoustic optical modulator (AOM).

As shown in FIG. 2(A), an observation apparatus 20 according to an embodiment includes a light source 21 that is a laser generation device, an acoustic optical modulator (AOM) 22 that modulates light into a pulse and outputs the pulse, a dichroic mirror 23, a piezo stage 24, an objective lens 25, a condenser lens 26, a pinhole 27, a detection unit 28, and a data processing unit 29. The observation apparatus 20 irradiates a sample 100 with light at first and second intensities I₁ and I₂ and thus creates first and second fluorescence images F₁ and F₂, and takes a difference in intensities of fluorescence between the created first and second fluorescence images F₁ and F₂, thereby creating a fluorescence image of the sample 100, autofluorescence being removed or reduced in the fluorescence image. The observation apparatus 20 can be formed using, for example, a confocal laser microscope.

Continuous-wave laser light emitted from the light source 21 is fed through the AOM 22 to be made into pulses, then reflected by the dichroic mirror 23, and condensed on the sample 100 by the objective lens 25. The sample 100 includes the fluorescent probe 10 according to an embodiment, and the light emitted from the sample 100, that is, from the fluorescent probe 10, passes through the objective lens 25 and the dichroic mirror 23, is then condensed by the condenser lens 26, and passes through the pinhole 27. After that, the intensity of the light is detected by the detection unit 28 including a photodiode. An intensity data of the light detected by the detection unit 28 is processed by the data processing unit 29 connected to the detection unit 28. A position of the objective lens 25 on the sample 100 is changed by the piezo stage 24, and a light condensing position on the sample 100 is scanned. Thereby, a two-dimensional fluorescence image of the sample 100 is created. In a case where the detection unit 28 includes a spectrometer, the data processing unit 29 creates a spectrum of the fluorescence emitted from the fluorescent probe 10.

The wavelength of the light emitted from the light source 21 includes a wavelength at which the color center of the diamond 1 that is the fluorescent probe 10 included in the sample 100 can be excited. In the present embodiment, the color center of the diamond 1 is the SiV center, and the light source 21 emits continuous-wave laser light having a wavelength of about 532 nm (green). The AOM 22 is a digital AOM, and the timing at which the AOM 22 outputs a pulse is controlled by controlling a voltage signal applied to the AOM 22. In the present embodiment, the dichroic mirror 23 is a long pass Dichroic Mirror with a wavelength of about 552 nm. The data processing unit 29 includes a processor configured to process data and a memory configured to record data. The data processing unit 29 can be constructed using various information terminal devices such as a publicly known general-purpose computer, a notebook PC, and a tablet terminal.

An example of an aspect in which the AOM 22 irradiates the sample 100 with light at a plurality of different intensities I₁ and I₂ will be described with reference to FIG. 2(B). In the view, the graphs shown on the left side show temporal change of the intensity of the laser light before passing through the AOM 22. The graphs shown on the right side show temporal change of the intensity of the laser light after passing through the AOM 22. The upper graphs show a case where the laser light is irradiated at the first intensity I₁. The lower graphs show a case where the laser light is irradiated at the second intensity I₂.

In the present embodiment, the AOM 22 that modulates the continuous-wave laser light into pulses and outputs the pulses controls intervals of the outputted pulses, thereby varying the intensity of the irradiated light per unit time, as shown in the graphs on the right side. Accordingly, the AOM 22 irradiates the sample 100 with light at a plurality of different intensities I₁ and I₂. In the present embodiment, the continuous-wave laser light is pulsed by the AOM 22 and irradiated at the first intensity I₁, and is irradiated at the second intensity I₂ while remaining in a continuous-wave mode. For example, m, in the intensities of the laser light, the first intensity I₁ is equal to 200 μW, the second intensity I₂ is equal to 2000 μW, and the first intensity I₁ is smaller than the second intensity I₂.

### Observation Method

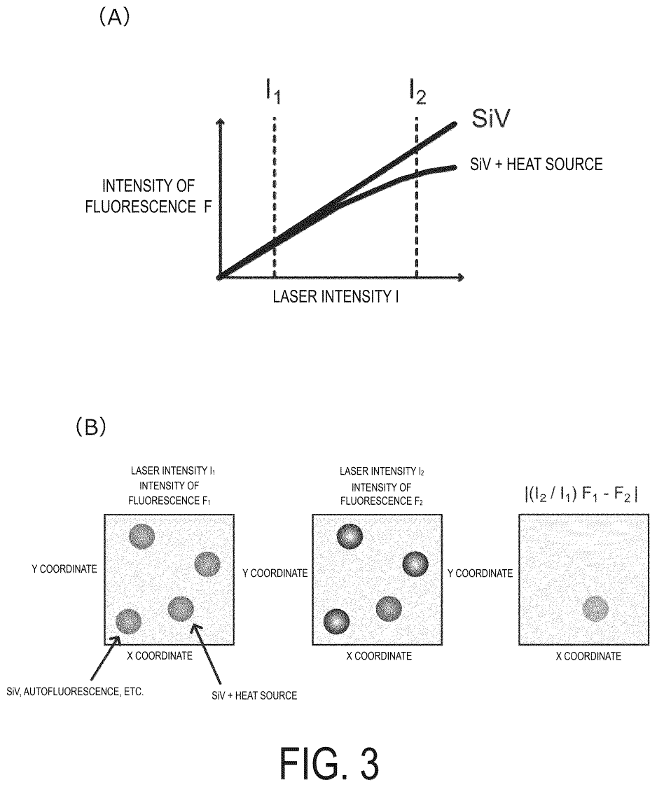

FIG. 3 is views for explaining a fluorescence observation method. (A) is a graph showing a relationship between an intensity of light irradiated onto a fluorescent probe and an intensity of fluorescence emitted from the fluorescent probe. (B) is schematic views for explaining that autofluorescence is removed by taking a difference in intensities of fluorescence between a plurality of fluorescence images F₁ and F₂ having different intensities to each other.

An observation method using a fluorescent probe according to an embodiment includes:
a first fluorescence image creating step including irradiating the fluorescent probe with light at a first intensity and creating a first fluorescence image;
a second fluorescence image creating step including irradiating the fluorescent probe with light at a second intensity higher than the first intensity and creating a second fluorescence image; and
an enhanced image creating step including taking a difference in intensities of fluorescence between the first fluorescence image and the second fluorescence image, and creating an enhanced image having a relatively enhanced intensity of the fluorescence emitted from the fluorescent probe when the fluorescent probe is irradiated with the light at the second intensity.

When the intensity of the irradiated light is corrected, the enhanced image creating step includes correcting the intensity of fluorescence of either the first fluorescence image or the second fluorescence image based on a ratio between the first intensity and the second intensity, taking the difference in intensities of fluorescence between the corrected one fluorescence image and the other fluorescence image, and thus creating the enhanced image.

As shown in FIG. 3(A), the fluorescent probe 10 according to an embodiment has nonlinearity between the intensity of the irradiated light and the intensity of the emitted fluorescence. On the other hand, in light and autofluorescence from the diamond particle 1 having a surface not coated with the substance 2 that absorbs light and releases heat, and having a bare color center, nonlinearity as large as that of the fluorescent probe 10 does not occur between an intensity of irradiated light and an intensity of emitted fluorescence. In comparison with the fluorescent probe 10, there is a substantially linear relationship between the intensity of the irradiated light and the intensity of the emitted fluorescence.

In the observation method according to an embodiment, the fluorescent probe 10 having such nonlinearity is irradiated with light at first and second intensities I₁ and I₂ and thus first and second fluorescence images F₁ and F₂ are created, and the difference in intensities of fluorescence between the created first and second fluorescence images F₁ and F₂ is obtained. Accordingly, the autofluorescence is removed or reduced without irradiating the fluorescent probe with microwaves for generating magnetic resonance.

An example of the observation method using the fluorescent probe 10 will be described with reference to FIG. 2(A) and 3(B). First, the light emitted from the light source 21 is condensed at a certain position on the surface of the sample 100. Next, the condensing position on the surface of the sample 100 is irradiated with the light at the first intensity I₁, the light emitted from the sample 100 is detected, and a first intensity of fluorescence is detected.

Subsequently, with the condensing position held as it is, the condensing position is irradiated with the light at a second intensity I₂ higher than the first intensity I₁, and the light emitted from the sample 100 is detected, and a second intensity of fluorescence is detected. Thereafter, while the position of the objective lens 25 is changed using the piezo stage 24, the condensing position for light on the sample 100 is scanned, and the detection of the first intensity of fluorescence and the second intensity of fluorescence is repeated for each pixel. When the light condensing position on the sample 100 is, for example, raster-scanned, first and second fluorescence images F₁ (x, y) and F₂ (x, y), corresponding to raster-scanned planar regions on the sample 100, are created respectively, as shown in FIG. 3(B).

The first and second fluorescence images F₁ and F₂ include not only the fluorescence emitted from the fluorescent probe 10 coated with the substance 2 that absorbs light and releases heat, but also light emitted from various emission sources. The first and second fluorescence images F₁ and F₂ include, for example; the fluorescence from the diamond particle 1 having a surface not coated with the substance 2 that absorbs light and releases heat, and having the bare color center; and autofluorescence that is unintended fluorescence from a cell.

In the fluorescent probe 10 according to an embodiment, nonlinearity occurs between the intensity of the irradiated light and the intensity of the emitted fluorescence, as described with reference to FIG. 3(A). In the first fluorescence image F₁ and the second fluorescence image F₂, the intensities of the irradiated light are different from each other, and the second intensity I₂ is higher than the first intensity I₁. Therefore, in the second fluorescence image F₂, the light emitted from the fluorescent probe 10 is captured with a lower intensity than that in the first fluorescence image F₁. On the other hand, the light and the autofluorescence from the diamond particle 1 having a surface not coated with the substance 2 that absorbs light and releases heat, and having a bare color center, are captured with higher intensities in the second fluorescence image F₂ than those in the first fluorescence image F₁, as the intensity of the irradiated light increases from the first intensity I₁ to the second intensity I₂. Therefore, when the difference in intensities of fluorescence between the first and second fluorescence images F₁ (x, y) and F₂ (x, y) is obtained, the light from the bare diamond particle 1 having the color center and the autofluorescence are removed, and only the light emitted from the fluorescent probe 10 remains in the image.

Preferably, the intensity of the irradiated light is corrected between the first and second fluorescence images F₁ and F₂, and then the difference in intensities of fluorescence between the first and second fluorescence images F₁ (x, y) and F₂ (x, y) is obtained. The intensity of the irradiated light is corrected by correcting the intensity of fluorescence of either the first fluorescence image F₁ or the second fluorescence image F₂ based on the ratio between the first intensity I₁ and the second intensity I₂, and by taking the difference in intensities of fluorescence between the corrected one fluorescence image and the other fluorescence image. For example, when the intensity of fluorescence of the first fluorescence image F₁, of the first and second fluorescence images F₁ and F₂, is corrected and the difference in intensities of fluorescence between the first and second fluorescence images F₁ and F₂ is obtained, the correction of the intensity of the irradiated light can be expressed as |(I₂/I₁)F₁−F₂|.

As described above, the fluorescent probe according to an embodiment is a fluorescent probe that can remove or reduce autofluorescence without irradiating the diamond containing the color center with microwaves,

The fluorescent probe 10 according to an embodiment is obtained by coating the surface of the diamond particle 1 having the color center with the substance 2 that absorbs light and releases heat. This allows nonlinearity to occur between the intensity of the light irradiated onto the fluorescent probe 10 and the intensity of the fluorescence emitted from the fluorescent probe. By irradiating such a fluorescent probe having the nonlinear relationship between the intensity of the irradiated light and the intensity of the emitted fluorescence, with light at the first and second intensities I₁ and I₂, the first and second fluorescence images F₁ and F₂ are created, and a difference in intensities of fluorescence is obtained between the created first and second fluorescence images F₁ and F₂. This makes it possible to observe a fluorescence image with autofluorescence being removed or reduced, without irradiating the fluorescent probe with microwaves for generating magnetic resonance. When the irradiation with microwaves is not required, it is possible to reduce a size of an apparatus used for the observation. Accordingly, when fluorescence observation of, for example, a cell or a virus is performed, it is possible to observe a fluorescence image with an improved S/N ratio by directly using a fluorescence microscope, and a confocal laser microscope known in the art. The observation of the fluorescence image using the fluorescent probe has been performed in virus detection or an antigen-antibody test (immunoassay), and the fluorescent probe 10 according to an embodiment can be used in the virus detection or the immunoassay.

As described above, the fluorescent probe according to an embodiment can remove or reduce autofluorescence without irradiating the diamond containing the color center with microwaves. The fluorescent probe according to an embodiment has an advantageous effect in, for example, the application examples described below, as compared with a type of fluorescent probe involving irradiation with microwaves in order to remove the autofluorescence.

For example, in fluorescence observation using the fluorescent probe according to an embodiment, when a laser light source that emits light having a wavelength in the near infrared region called biological NIR window (about 620 to 950 nm) wavelength is used as an excitation light source, the fluorescence observation can be performed deeper in a tissue or a deep region of the human body where microwaves cannot reach, as well as at the whole-body level. This is an advantageous effect compared to a type of the fluorescent probe involving irradiation with microwaves in order to remove autofluorescence. In particular, in a case where the SiV center is used as the color center of the diamond, the SiV center is advantageous because it is excited and emits fluorescence even with irradiated light having a long wavelength of about 600 nm or more. In addition, according to the fluorescent probe of an embodiment, it is possible to increase light absorption efficiency, so that the fluorescent probe is expected to be used as a new contrast agent or imaging agent for photoacoustic imaging. In addition, the fluorescent probe according to an embodiment can also be used for photothermal therapy (hyperthermia). For example, the fluorescent probe is administered to a patient, and the probe that has reached a deep lesion site by its EPR effect (vascular permeability and enhanced retention effect) is confirmed by fluorescence, and at the same time, an light irradiation amount is increased by utilizing the high light absorption efficiency of the probe, whereby selective heating and thermal therapy of the lesion site can be performed.

### Other Embodiments

Although the present invention has been described above with reference to specific embodiments, the present invention is not limited to the above-described embodiments.

In the above embodiments, in the observation method using the fluorescent probe, the second intensity I₂ is higher than the first intensity I₁, and the fluorescent probe 10 is irradiated with light of the first intensity I₁ and of the second intensity I₂ (I₂>I₁) in this order, but the order of irradiating the fluorescent probe 10 with light is not limited to the above order. In another embodiment, the second intensity I₂ is higher than the first intensity I₁, and the fluorescent probe 10 may be irradiated with light of the second intensity I₂ (I₂>I₁) and of the first intensity I₁ in this order. That is, in the observation method using the fluorescent probe according to an embodiment, the order of performing the first fluorescence image creating step and the second fluorescence image creating step may be switched. The observation method using a fluorescent probe described in the claims also includes, in the claims, an aspect in which the order of performing the first fluorescence image creating step and the second fluorescence image creating step is switched.

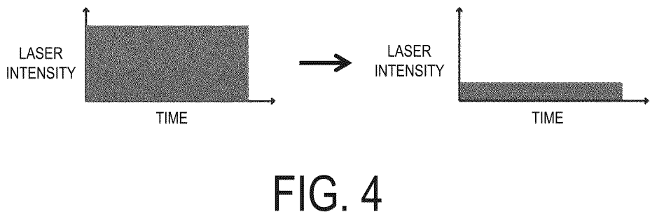

FIG. 4 is views for explaining a function of an analog acoustic optical modulator (AOM). In the above embodiments, the sample 100 is irradiated with light at a plurality of different intensities I₁ and I₂ by controlling intervals of the outputted pulses using the AOM 22 and varying the intensity of the irradiated light per unit time, as shown in the upper and lower graphs on the right side in FIG. 2(B), but the method of setting the intensity of the irradiated light to the plurality of different intensities I₁ and I₂ is not limited to such an irradiation. For example, as shown in FIG. 4, the intensity of the continuous-wave laser light may be varied by using an analog AOM. The analog AOM 22 can vary the intensity of the outputted light according to the applied voltage.

In the above embodiments, the fluorescence image is created by directly detecting the light emitted from the sample 100, but the fluorescence image may be created by detecting the light emitted from the sample 100 and passing through the wavelength filter. The wavelength filter may be disposed, for example, in an optical line between the dichroic mirror 23 and the detection unit 28. As will be described in the examples below, a peak wavelength of the fluorescence emitted from the color center including the SiV center shifts to a long wavelength side with an increase in temperature. Therefore, when the second fluorescence image F₂ is created by irradiating with light at the second intensity I₂ higher than the first intensity I₁, and when the second fluorescence image F₂ is created by the light transmitted through a long-pass filter having an edge near a wavelength peak of a zero-phonon line, the long-pass filter being disposed at the above-described position of the optical line, the long-pass filter transmits light having a wavelength longer than the wavelength of the zero-phonon line of the color center, so that the signal-to-noise ratio can be further improved. Similarly, when the first fluorescence image F₁ is created by irradiating with light at the first intensity I₁, and when the first fluorescence image F₁ is created by the light transmitted through a short-pass filter having an edge near the wavelength peak of the zero-phonon line, the signal-to-noise ratio can be further improved.

Hereinafter, examples of the present invention will be described to further clarify the features of the present invention.

### Example 1

In Example 1, a fluorescent probe according to an embodiment of the present invention was actually produced, and fluorescence observation was performed using the produced fluorescent probe.

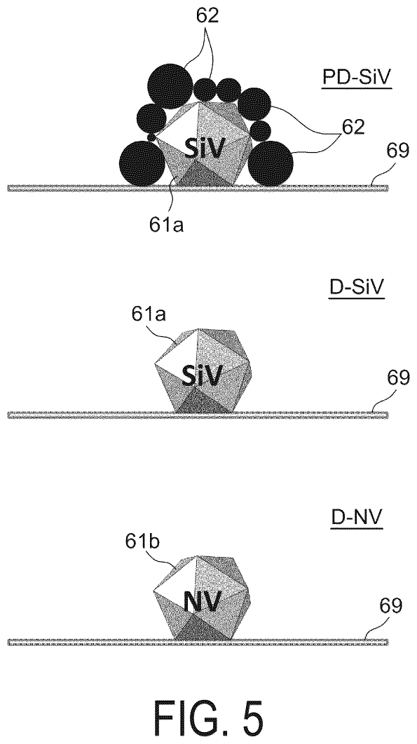

FIG. 5 is views schematically showing three kinds of fluorescent probes produced on glass substrates as examples and comparative examples in Example 1 to Example 3. As a fluorescent probe according to an example of the present invention, a fluorescent probe (hereinafter, also referred to as PD-SiV), in which a surface of a microdiamond 61a having an SiV center was coated with polydopamine (PDA) 62, was produced on a glass substrate 69. As comparative examples, two kinds of fluorescent probes were produced on the same glass substrate 69. As a fluorescent probe according to a first comparative example, a microdiamond 61a having an SiV center (hereinafter, also referred to as D-SiV) was produced. In the fluorescent probe according to the first comparative example, the surface of the microdiamond 61a having the SiV center is not coated with polydopamine (PDA). As a fluorescent probe according to a second comparative example, a microdiamond 61b having an NV center (hereinafter, also referred to as D-NV) was produced. In the fluorescent probe according to the second comparative example, the surface of the microdiamond 61b having the NV center is not coated with polydopamine (PDA). As described later, a nanodiamond, having a size smaller than that of the microdiamond 61a used in Examples 1 and 2, was used in Example 3.

The fluorescent probe according to the example was produced on the glass substrate by a procedure described below. First, a solvent for the microdiamond was replaced with a Tris-HCl buffer solution (pH: about 8.5) using an ultracentrifuge. Next, 4 mg of TEMPO was added to the buffer solution, and TEMPO was dissolved by ultrasonication in an ice bath. The ultrasonication in the ice bath was performed in a cycle of 10 seconds on and 10 seconds off, repeated on and off, for a total of 10 minutes. Next, 0.5 mg of dopamine hydrochloride ((HO)₂C₆H₃CH₂CH₂NH₂·HCl) powder was added to the buffer solution. After adding the dopamine hydrochloride powder, a polymerization reaction was started and polydopamine (PDA) coating on the surface of the microdiamond was started. During this time, the reaction mixture was continuously subjected to the ultrasonication in the ice bath in the repeated cycles described above. Two hours after starting the coating, the mixture was washed to remove the reactant (dopamine hydrochloride) and the coating reaction was stopped once. The coated microdiamond was recovered by repeating a separation operation by the ultracentrifuge (about 9000 rpm, 10 minutes) three times after ultrapure water was added. Such a coating reaction on the surface of the diamond was repeated 1 to 5 times to produce a polydopamine film having a thickness most suitable for the observation even with a weak laser intensity of light. In order to prevent intermolecular aggregation, the coating reaction time per cycle was set to 2 hours that is a relatively short time. As the microdiamond, a SiV microdiamond manufactured by Adamas Nanotechnologies, Inc. in the United States was used.

Next, fluorescence observation was performed using the produced fluorescent probes. The fluorescence observation was performed by irradiating each of the fluorescent probes produced on the glass substrate with light at first and second intensities, creating first and second fluorescence images having different intensities, correcting the intensity of the irradiated light, and then taking a difference in intensities of fluorescence between the created first and second fluorescence images. Each of the intensities of the irradiated light were set to satisfy that the first intensity was smaller than the second intensity. The wavelength of the light irradiated onto the fluorescent probes was about 532 nm.

FIG. 6 is fluorescence images observed in Example 1, which are fluorescence images obtained by the fluorescence observation using the fluorescent probes. (A) is a second fluorescence image obtained when each of the produced fluorescent probes is irradiated with light at a second intensity higher than a first intensity. (B) is a fluorescence image obtained by correcting the intensity of the irradiated light and then taking the difference in intensities of fluorescence between the first and second fluorescence images.

As shown by broken line frames in the fluorescence image of (A), five fluorescences were confirmed on the glass substrate in the field of view. Among these, there were two fluorescences emitted from the PD-SiV according to the example, single fluorescence emitted from the D-SiV according to the first comparative example, and two fluorescences emitted from the D-NV according to the second comparative example.

The fluorescence images were compared between (A) and (B). It was confirmed that, as shown in the fluorescence image of (B), the intensities of the two fluorescences from the PD-SiV which was the fluorescent probe according to the example, were relatively enhanced. On the other hand, it was confirmed that all of the fluorescence from the D-SiV and the fluorescences from the D-NV, the D-SiV and the D-NV being the fluorescent probes according to the respective comparative examples, almost disappeared or the intensities of these fluorescences were relatively reduced.

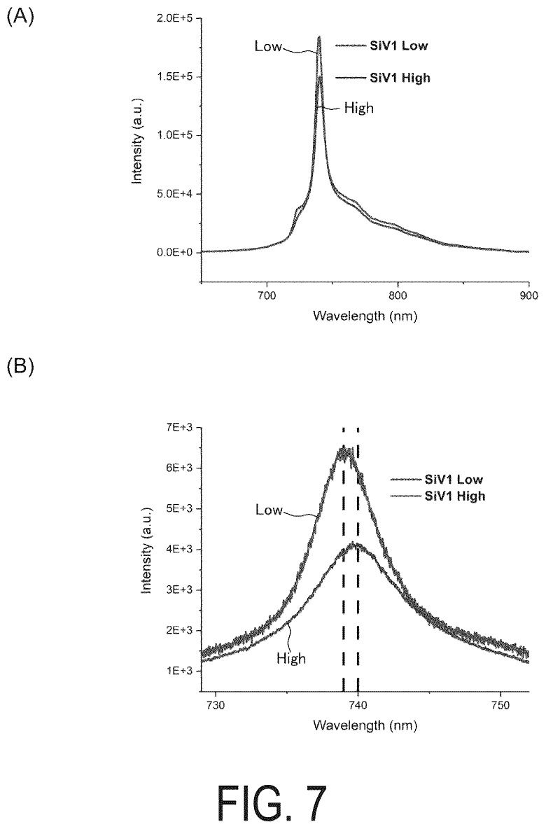

Next, a fluorescence spectrum was measured for each of the five fluorescences confirmed on the glass substrate in the field of view. The measurement results of the fluorescence spectra are shown in FIGS. 7 to 11. In each of the fluorescence spectra of FIGS. 7 to 11, each of the intensities of fluorescence on the vertical axis is adjusted to easily compare the shapes of the spectra, and the shown values do not represent the raw measured values of the intensities of fluorescence.

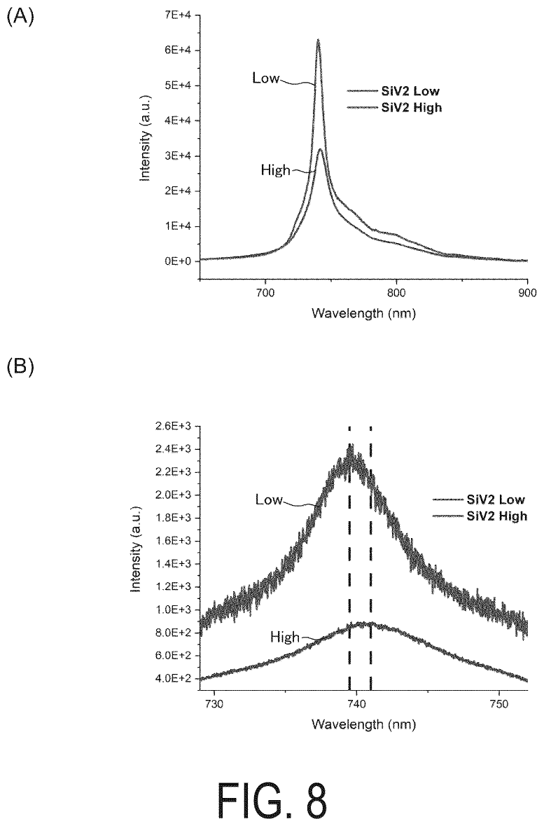

FIGS. 7 and 8 are spectra measured in Example 1, which are spectra of the fluorescence emitted from PD-SiV whose surface is coated with polydopamine, the PD-SiV being the fluorescent probe according to the example. Each (B) is an enlarged view around the peak wavelengths of the fluorescence spectra shown in each (A). It was confirmed that, as shown in each of the fluorescence spectra in FIG. 7(B) and 8(B), the detected intensity of fluorescence decreased as the intensity of the irradiated light increased (from Low to High). Accordingly, it was confirmed that the fluorescent probe according to the example has a nonlinear relationship between the intensity of the irradiated light and the intensity of the emitted fluorescence. In addition, it was confirmed that, when the intensity of the irradiated light increased, the wavelength at which the intensity reached a peak also shifted to a long wavelength side.

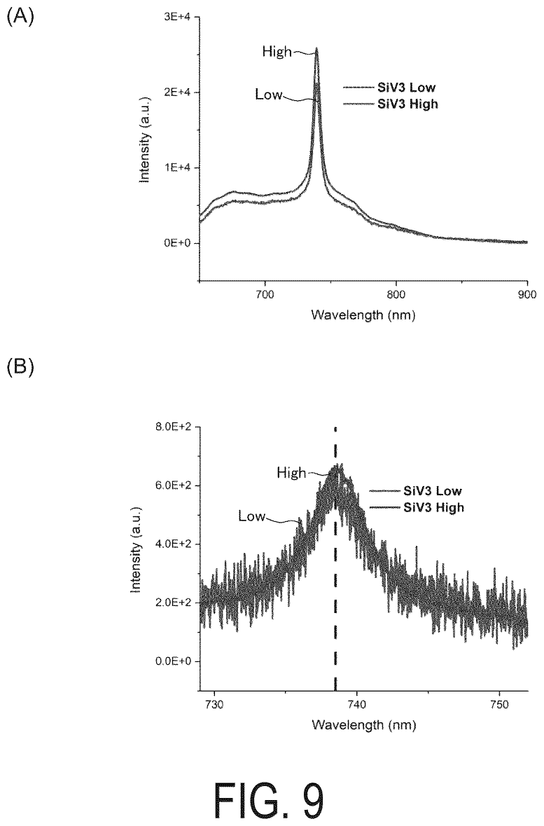

FIG. 9 is spectra measured in Example 1, which are spectra of the fluorescence emitted from the D-SiV whose surface is not coated, the D-SiV being the fluorescent probe according to the first comparative example. (B) is an enlarged view around the peak wavelengths of the fluorescence spectra shown in (A). It was confirmed that, as shown in each of the fluorescence spectra in FIG. 9(B), the detected intensity of fluorescence did not decrease even when the intensity of the irradiated light increased (from Low to High).

The detected intensity of fluorescence increased slightly as the intensity of the irradiated light increased. In addition, no shift of the wavelength at which the intensity reached a peak was observed even when the intensity of the irradiated light increased.

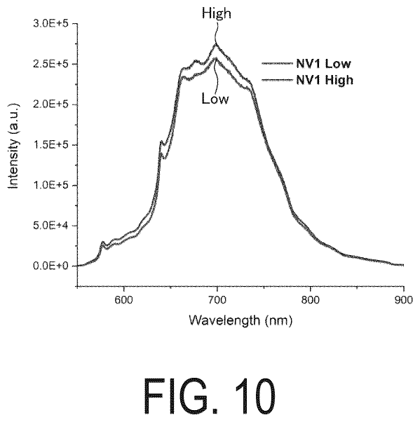

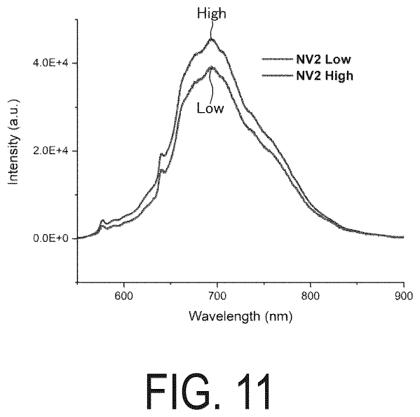

FIGS. 10 and 11 are spectra measured in Example 1, which are spectra of the fluorescence emitted from the D-NV whose surface is not coated, the D-NV being the fluorescent probe according to the second comparative example. It was confirmed that, as shown in the fluorescence spectra in FIGS. 10 and 11, the detected intensity of fluorescence did not decrease even when the intensity of the irradiated light increased (from Low to High). The detected intensity of fluorescence increased slightly as the intensity of the irradiated light increased. In addition, no shift of the wavelength at which the intensity reached a peak was observed even when the intensity of the irradiated light increased.

As described above, it was confirmed that the fluorescent probe according to the example has a nonlinear relationship between the intensity of the irradiated light and the intensity of the emitted fluorescence. According to the fluorescence observation using the fluorescent probe of the example, by taking the difference in intensities of fluorescence between the plurality of fluorescence images having different intensities to each other, it was confirmed that all the fluorescences emitted from the fluorescent probes other than the fluorescent probe according to the example almost disappeared or the intensities of the fluorescences were relatively reduced.

### Example 2

Also, in Example 2, fluorescence observation was performed using the produced fluorescent probe, in the same manner as that in Example 1. In Example 2, the fluorescent probes according to the example were newly produced on another glass substrate different from that in Example 1 by the same production method as that of Example 1. A microdiamond used for the production was also the same SiV microdiamond manufactured by Adamas Nanotechnologies, Inc. in the United States as that in Example 1. The fluorescence observation using the produced fluorescent probe was also performed in the same manner as that in Example 1.

FIG. 12 is fluorescence images observed in Example 2, which are fluorescence images obtained by the fluorescence observation using fluorescent probes. (A) is a second fluorescence image obtained when each of the produced fluorescent probes is irradiated with light at a second intensity higher than a first intensity. (B) is a fluorescence image obtained by correcting the intensity of the irradiated light and then taking the difference in intensities of fluorescence between the first and second fluorescence images.

The fluorescence images were compared between (A) and (B). It was confirmed that, as shown in the fluorescence image of (B), the intensity of the fluorescence from the PD-SiV, which is the fluorescent probe according to the example, was relatively enhanced. On the other hand, it was confirmed that the fluorescence from the D-SiV or the fluorescence from the D-NV, the D-SiV and the D-NV being the fluorescent probes according to the comparative examples, almost disappeared or the intensity was relatively reduced.

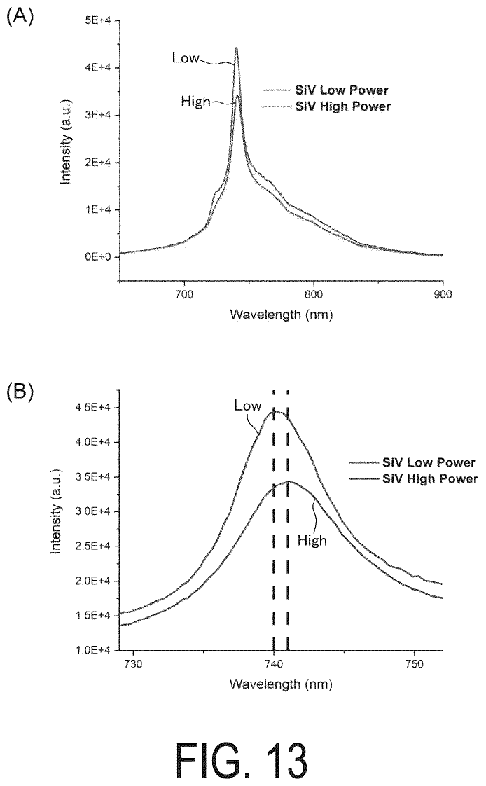

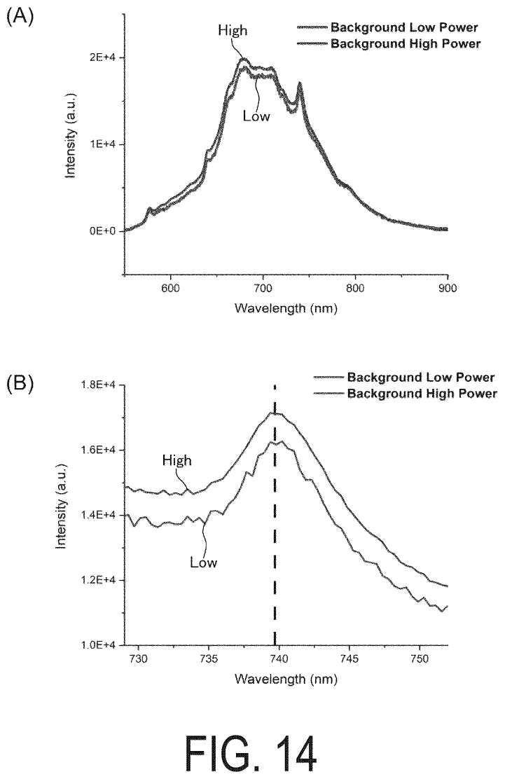

Next, the fluorescence spectrum was measured for each of the fluorescences confirmed on the glass substrate in the field of view. The measurement results of the fluorescence spectra are shown in FIGS. 13 to 14. In each of the fluorescence spectra of FIGS. 13 to 14, each of the intensities of fluorescence on the vertical axis is also adjusted to easily compare the shapes of the spectra, as well as FIGS. 7 to 11, and the shown values do not represent the raw measured values of the intensities of fluorescence.

FIG. 13 is spectra measured in Example 2, which are spectra of fluorescence emitted from PD-SiV whose surface is coated with polydopamine, the PD-SiV being the fluorescent probe according to the example. Each (B) is an enlarged view around the peak wavelengths of the fluorescence spectra shown in each (A). It was confirmed that, as shown in each of the fluorescence spectra in (B), the detected intensity of fluorescence decreased when the intensity of the irradiated light increased (from Low to High). Accordingly, it was confirmed that the fluorescent probe according to the example has a nonlinear relationship between the intensity of the irradiated light and the intensity of the emitted fluorescence. In addition, it was confirmed that, when the intensity of the irradiated light increased, the wavelength at which the intensity reached a peak also shifted to a long wavelength side.

FIG. 14 is spectra measured in Example 2, which are spectra of fluorescence emitted from D-SiV whose surface is not coated, or of fluorescence emitted from D-NV whose surface is not coated, the D-SiV and the D-NV being fluorescent probes according to the comparative examples. (B) is an enlarged view around the peak wavelengths of the fluorescence spectra shown in (A). It was confirmed that, as shown in each of the fluorescence spectra in (B), the detected intensity of fluorescence did not decrease even when the intensity of the irradiated light increased (from Low to High). The detected intensity of fluorescence increased slightly as the intensity of the irradiated light increased. In addition, no shift of the wavelength at which the intensity reached a peak was observed even when the intensity of the irradiated light increased.

As described above, it was confirmed that the fluorescent probe according to the example has a nonlinear relationship between the intensity of the irradiated light and the intensity of the emitted fluorescence. According to the fluorescence observation using the fluorescent probe of the example, by taking the difference in intensities of fluorescence between the plurality of fluorescence images having different intensities to each other, it was confirmed that all the fluorescences emitted from the fluorescent probes other than the fluorescent probe according to the example almost disappeared or the intensities of the fluorescences were relatively reduced.

### Example 3

Also, in Example 3, a fluorescent probe according to the present invention was actually produced, and fluorescence observation was performed using the produced fluorescent probe, in the same manner as that in Example 1. In Example 3, a nanodiamond, having a size smaller than that of the microdiamond used in Examples 1 and 2, was used.

In Example 3, an SiV nanodiamond obtained by a detonation method was used as the nanodiamond. The SiV nanodiamond was prepared by the following procedure.

Using approximately 1 kg of an explosive composition obtained by adding 1 part by mass of triphenylsilanol as a heteroatom compound to 100 parts by mass of an explosive containing trinitrotoluene (TNT) and cyclotrimethylene trinitramine (RDX), a silicon-doped nanodiamond was produced in accordance with an ordinary method for nanodiamond production. The obtained silicon-doped nanodiamond was subjected to the following treatments (i) to (iv). Note that the added amount of triphenylsilanol in the explosive was 1 mass %.

### (i) Mixed Acid Treatment

15 g of nanodiamonds obtained in a detonation test was added to 2800 g of a mixed acid of concentrated sulfuric acid: concentrated nitric acid=11:1 (weight ratio), and the mixture was treated at 150 °C for 10 hours with stirring.

(ii) Alkali treatment

To 100 mL of an 8 N aqueous solution of sodium hydroxide, 1 g of the nanodiamonds treated with the mixed acid was added, and the mixture was treated at 70 °C for 8 hours with stirring.

(iii) Gas Phase Oxidation Treatment

The obtained Si-doped nanodiamond raw material was subjected to a gas phase oxidation treatment in a gas atmosphere furnace at 570 °C in a 4% oxygen atmosphere for 2 hours to yield Si-doped nanodiamond particles.

The obtained Si-doped nanodiamond particles were subjected to high-speed mapping and brightness imaging at 738 nm using a micro-Raman spectrometer (product name: Micro laser Raman spectrophotometer LabRAM HR Evolution, manufactured by HORIBA, Ltd.), and the intensity of fluorescence and the number of brightness (central portion, intermediate layer, outer peripheral portion) were measured. Furthermore, the average size of primary particles was measured based on the Scherrer equation by a powder X-ray diffraction method (XRD) using a fully automatic multi-purpose X-ray diffractometer (manufactured by Rigaku Corporation). Furthermore, an amount of Si introduced was measured by XRF using an X-ray fluorescence analyzer ZSX Primus IV manufactured by Rigaku Corporation. Furthermore, a peak area ratio between sp² carbon and sp³ carbon was measured by micro Raman spectroscopy using a micro-Raman spectrometer (product name: Micro laser Raman spectrophotometer LabRAM HR Evolution, manufactured by HORIBA, Ltd.). Using a laser of 325 nm for the measurement, the peak area of the sp² carbon referred to the areas of peaks that appear near 1250 cm⁻¹ and 1328 cm⁻¹, and the peak area of the sp³ carbon referred to the areas of peaks that appear near 1500 cm⁻¹ and 1590 cm⁻¹. The average particle size of the produced nanodiamonds was about 10.8 nm.

(iv) High-temperature long-time mixed acid treatment The nanodiamond particles obtained in the gas phase oxidation treatment (iii) were added to a mixed acid of concentrated sulfuric acid:concentrated nitric acid=3:1 (weight ratio), and a mixed acid treatment was performed at 130 °C for 72 hours. The nanodiamonds treated with the mixed acid were recovered by centrifugation and repeatedly washed with pure water. The nanodiamonds recovered after the washing were subjected to a drying step and a nanodiamond powder was obtained.

A fluorescent probe using the nanodiamond containing the SiV center according to Example 3 was produced on a glass substrate in the same procedure as that in Example 1 except that ultrasonication in an ice bath was continued until TEMPO was dissolved (typically, for about 10 minutes). The average particle size of the nanodiamonds used for the production was about 10.8 nm. The fluorescence observation using the produced fluorescent probe was also performed in the same manner as that in Example 1. In Example 3, however, a laser intensity during the fluorescence observation was set such that the first intensity I₁ was higher than the second intensity I₂ (I₁>I₂), unlike Example 1.

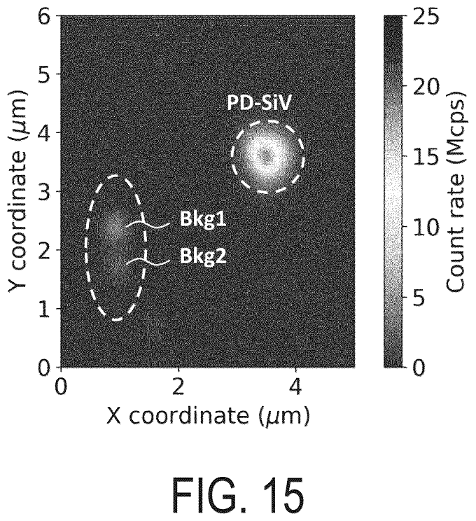

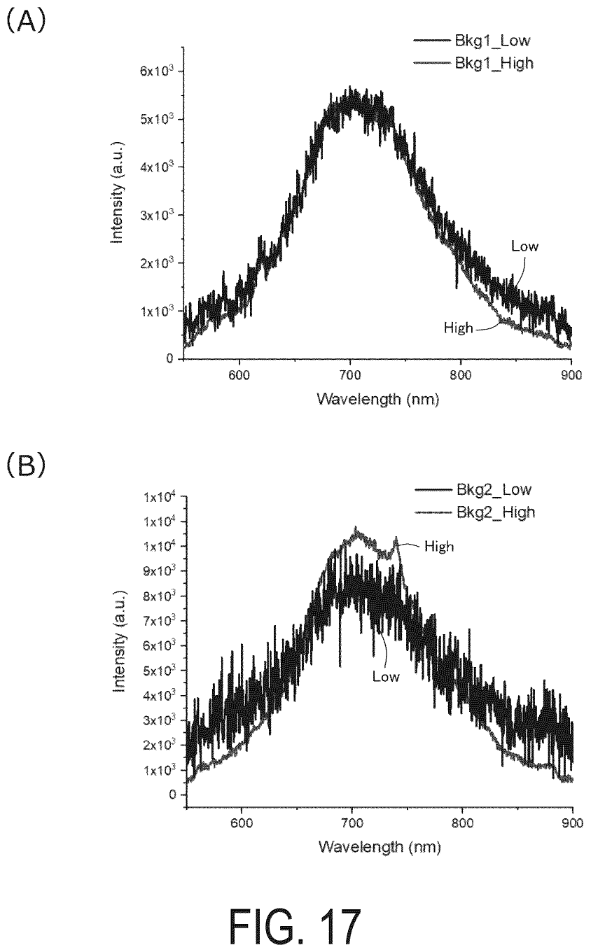

FIG. 15 is a fluorescence image obtained by the fluorescence observation using the fluorescent probe according to Example 3. The fluorescence image of FIG. 15 is a first fluorescence image obtained when the produced fluorescent probe is irradiated with light at the first intensity I₁ (I₁>I₂). As shown by broken line frames in the fluorescence image of the view, three fluorescences were confirmed on the glass substrate in the field of view. Among these, there is the single fluorescence from PD-SiV, which was the fluorescent probe according to Example 3. From the consideration regarding FIG. 17 described later, it is considered that the remaining two fluorescences are not the fluorescences from the produced fluorescent probe according to Example 3, and thus, in the following description, these two fluorescences will be referred to with labels “Bkg1” and “Bkg2” respectively.

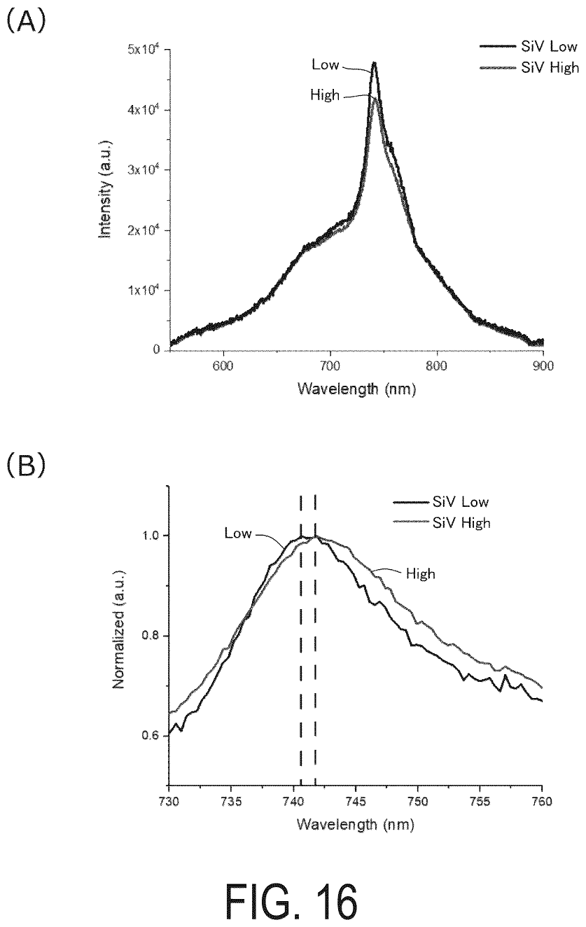

FIG. 16 is spectra of fluorescence indicated by a label “PD-SiV” in FIG. 15. (B) is an enlarged view around the peak wavelengths of the fluorescence spectra shown in (A). Note that, in (B), each of the intensities of fluorescence is normalized so that each of the maximum values is 1. It was confirmed that, as shown in the fluorescence spectra in (A), the detected intensity of fluorescence increased when the intensity of the irradiated light decreased (from High to Low). Accordingly, it was confirmed that the fluorescent probe according to Example 3 also has a nonlinear relationship between the intensity of the irradiated light and the intensity of the emitted fluorescence. In addition, it was confirmed that, as shown in the fluorescence spectra in (B), the wavelength at which the intensity reached a peak also shifted to a short wavelength side when the intensity of the irradiated light decreased.

FIG. 17 is spectra of fluorescence indicated by the label “Bkg1” or “Bkg2” in FIG. 15. (A) is the spectra of the fluorescence indicated by the label “Bkg1” in FIG. 15, while (B) is the spectra of the fluorescence indicated by the label “Bkg2” in FIG. 15. It was confirmed that, for the fluorescences labeled with “Bkg1” and “Bkg2”, the detected intensities of fluorescence did not increase even when the intensities of the irradiated light decreased (from High to Low), as shown in the fluorescence spectra in (A) and (B). The detected intensities of fluorescence decreased slightly when the intensities of the irradiated light decreased. In addition, no shift of the wavelengths at which the intensities reached respective peaks was observed even when the intensities of the irradiated light decreased.

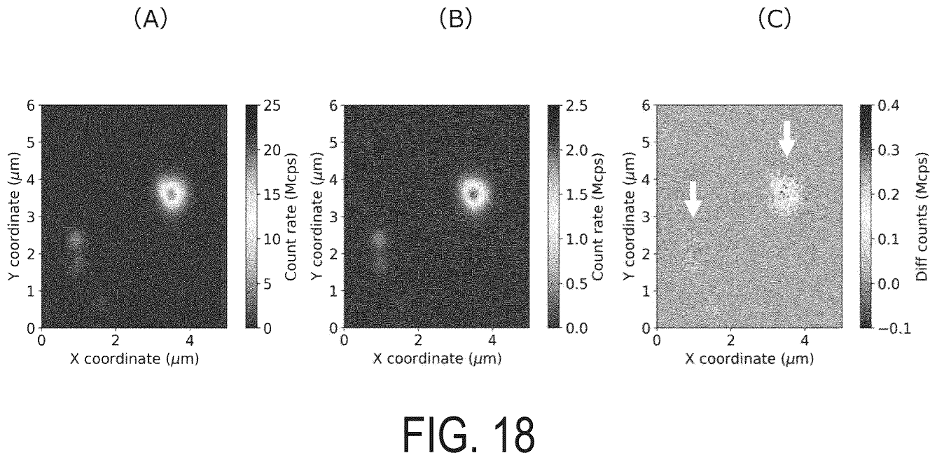

FIG. 18 is fluorescence images obtained by the fluorescence observation using the fluorescent probes according to Example 3, which are the respective fluorescence images obtained when the fluorescent probes are irradiated with light at different intensities. (A) is a first fluorescence image obtained when the produced fluorescent probe is irradiated with light at a first intensity. (B) is a second fluorescence image obtained when the produced fluorescent probe is irradiated with light at a second intensity lower than the first intensity. (C) is a fluorescence image obtained by correcting the intensity of the irradiated light and then taking a difference in intensities of fluorescence between the first and second fluorescence images. Note that, in the fluorescence image of (C), the fluorescence indicated by an arrow on the right side is the fluorescence indicated by the label “PD-SiV” in FIG. 15, while the fluorescence indicated by an arrow on the left side is the fluorescences indicated by the labels “Bkg1” and “Bkg2” in FIG. 15.

The fluorescence images in FIG. 18 will be considered. When changes between the intensities of the irradiated light and the detected intensities of fluorescence were confirmed across the fluorescence images (A) to (C), it was confirmed that, for the fluorescence indicated by the arrow on the right side in the fluorescence image of (C), which corresponds to the fluorescence indicated by the label “PD-SiV” in FIG. 15, the relative intensity of fluorescence changed nonlinearly.

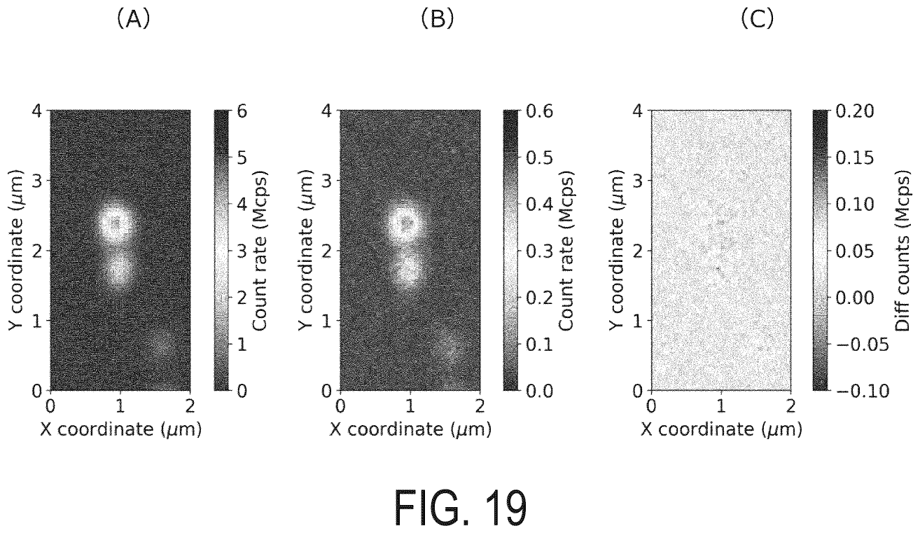

FIG. 19 is fluorescence images including the portions indicated by the labels “Bkg1” and “Bkg2” in FIG. 15, among the fluorescence images shown in FIG. 18.

The fluorescence images in FIG. 19 will be considered. When a change between the intensities of the irradiated light and the detected intensities of fluorescence were confirmed across the fluorescence images (A) to (C), it was confirmed that the change in the intensity of fluorescence was substantially linear and there was a substantially linear relationship between the intensities of the irradiated light and the intensities of the emitted fluorescence. That is, for the fluorescences indicated by the labels “Bkg1” and “Bkg2” in FIG. 15, it was confirmed that the fluorescences almost disappeared by taking the difference in intensities of fluorescence between a plurality of fluorescence images having different intensities.

As described above, it was confirmed that, also for the fluorescent probe according to Example 3 in which the nanodiamond having the size smaller than that of the microdiamond used in Examples 1 and 2 was used, the relationship between the intensity of the irradiated light and the intensity of the emitted fluorescence was nonlinear, as with Examples 1 and 2.

Although the fluorescent probe is produced using the SiV nanodiamond obtained by the detonation method in Example 3, the nanodiamond used for producing the fluorescent probe is not limited to the nanodiamond obtained by the detonation method. Examples of methods other than the detonation method for doping the nanodiamond with a different element (e.g., Si) include a high pressure and high temperature (HPHT) method, a CVD method, and an implosion method. In these exemplified methods, an SiV microdiamond or SiV nanodiamond can be produced by introducing an Si element during the diamond synthesis, or by implanting a Si ion later into a diamond particle that does not contain an Si element. A microdiamond or nanodiamond, having a complex defect and obtained by these methods, can be used for producing the fluorescent probe.

### REFERENCE SIGNS LIST

1 Diamond
2 Substance that absorbs light and releases heat
10 Fluorescent probe
20 Observation apparatus
21 Light source
22 Acoustic optical modulator (AOM)
23 Dichroic mirror
24 Piezo stage
25 Objective lens
26 Condenser lens
27 Pinhole
28 Detection unit
29 Data processing unit
61a Diamond containing SiV center
61b Diamond containing NV center
62 Polydopamine (PDA)
69 Glass substrate
100 Sample

1. A fluorescent probe, wherein a surface of a diamond particle having a color center is coated with a substance that absorbs light and releases heat.

2. The fluorescent probe according to claim 1, wherein a relationship between an intensity of irradiated light and an intensity of emitted fluorescence is nonlinear.

3. The fluorescent probe according to claim 1, wherein a free radical is added to the substance that absorbs light and releases heat.

4. The fluorescent probe according to claim 1, wherein the substance includes at least one of a dye molecule, graphene, graphite, a carbon nanotube, a polymer compound, a metal nanoparticle, an organic nanoparticle, or an inorganic nanoparticle.

5. The fluorescent probe according to claim 1, wherein the substance is polydopamine.

6. The fluorescent probe according to claim 1, wherein the color center is a silicon-vacancy complex defect.

7. An observation method using a fluorescent probe, the observation method comprising:
a first fluorescence image creating step including irradiating the fluorescent probe described in claim 1 with light at a first intensity and creating a first fluorescence image;
a second fluorescence image creating step including irradiating the fluorescent probe with light at a second intensity higher than the first intensity and creating a second fluorescence image; and
an enhanced image creating step including taking a difference in intensities of fluorescence between the first fluorescence image and the second fluorescence image, and creating an enhanced image having a relatively enhanced intensity of the fluorescence emitted from the fluorescent probe when the fluorescent probe is irradiated with the light at the second intensity.

8. The observation method according to claim 7, wherein
the enhanced image creating step includes correcting the intensity of fluorescence of either the first fluorescence image or the second fluorescence image based on a ratio between the first intensity and the second intensity, taking a difference in intensities of fluorescence between the corrected one fluorescence image and the other fluorescence image, and thus creating the enhanced image.

9. The observation method according to claim 7, wherein
the second fluorescence image creating step includes creating the second fluorescence image from fluorescence emitted from the fluorescent probe and passing through a wavelength filter, and
the wavelength filter is a long-pass filter configured to transmit light having a wavelength longer than a wavelength of a zero-phonon line of a color center included in the fluorescent probe.

10. The observation method according to claim 7, wherein
the first fluorescence image creating step includes creating the first fluorescence image from fluorescence emitted from the fluorescent probe and passing through a wavelength filter, and
the wavelength filter is a short-pass filter configured to transmit light having a wavelength shorter than a wavelength of a zero-phonon line of a color center included in the fluorescent probe.
